(19) United States
(12) Patent Application Publication
(10) Pub. No.: US 2008/0240098 A1
(43) Pub. Date: Oct. 2, 2008

(54) METHOD AND APPARATUS FOR PROVIDING FLEXIBLE VIRTUAL FORWARDING TABLE

(76) Inventors: JAMES UTTARO, Staten Island, NY (US); Eric Rosenberg, Lincroft, NJ (US); Mark Sundt, Red Bank, NJ (US)

Correspondence Address: Mr. John Etchells;AT&T Corp., Room 2A-207, One AT&T Way, Bedminster, NJ, 07921, US

(21) Appl. No.: 11/691,183

(22) Filed: Mar. 26, 2007

(51) Int. Cl. H04L 12/56

(52) U.S. Cl. 370/392

(57) ABSTRACT

A method and apparatus for providing a flexible virtual forwarding table for packet networks are disclosed. For example, the method receives one or more packets from at least one customer endpoint device, where the one or more packets are destined for a destination node. The method then locates a route for routing the one or more packets by consulting one or more virtual forwarding projection tables, wherein each of the one or more virtual forwarding projection tables contains a subset of the routes that are stored in a virtual route forwarding table. Finally, the method forwards the one or more packets towards said destination node using said route.

The present invention relates generally to communication networks and, more particularly, to a method and apparatus for providing a flexible virtual forwarding table for packet networks, e.g., Internet Protocol (IP) networks and Virtual Private Networks (VPNs).

### BACKGROUND OF THE INVENTION

An enterprise customer may build a Virtual Private Network (VPN) by connecting multiple sites or users over a network from a telephony service provider. The enterprise customer's devices such as Customer Edge (CE) routers may be connected to the provider's network through Provider Edge (PE) routers. If an enterprise customer site, e.g., a VPN site, has multiple interfaces, e.g., CEs, accessing the network through the same PE router, then the multiple interfaces will share a Virtual Route Forwarding (VRF) table. However, if a customer needs a different VRF table to be used for a different set of interfaces, then the service provider has to instantiate the entire VRF for those interfaces. That means all the routes have to be duplicated for each unique forwarding instance. Duplication of all routes for each forwarding instance is very costly. Furthermore, the approach is not easily scalable to large VPN networks with several sites, and varying needs at each site.

Therefore, there is a need for a method that provides a flexible virtual forwarding table on packet networks.

### SUMMARY OF THE INVENTION

In one embodiment, the present invention discloses a method and apparatus for providing a flexible virtual forwarding table for packet networks, e.g., Internet Protocol (IP) networks. For example, the method receives one or more packets from at least one customer endpoint device, where the one or more packets are destined for a destination node. The method then locates a route for routing the one or more packets by consulting one or more virtual forwarding projection tables, wherein each of the one or more virtual forwarding projection tables contains a subset of the routes that are stored in a virtual route forwarding table. Finally, the method forwards the one or more packets towards said destination node using said route.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with the current invention for providing flexible virtual route forwarding.

FIG. 3 illustrates a flowchart of a method for providing flexible virtual route forwarding; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a flexible virtual forwarding table for packet networks, e.g., Voice over Internet Protocol (VoIP) networks, Virtual Private Networks (VPN), etc. Although the present invention is discussed below in the context of VoIP and VPN networks, the present invention is not so limited. Namely, the present invention can be applied for other packet networks such as the cellular networks.

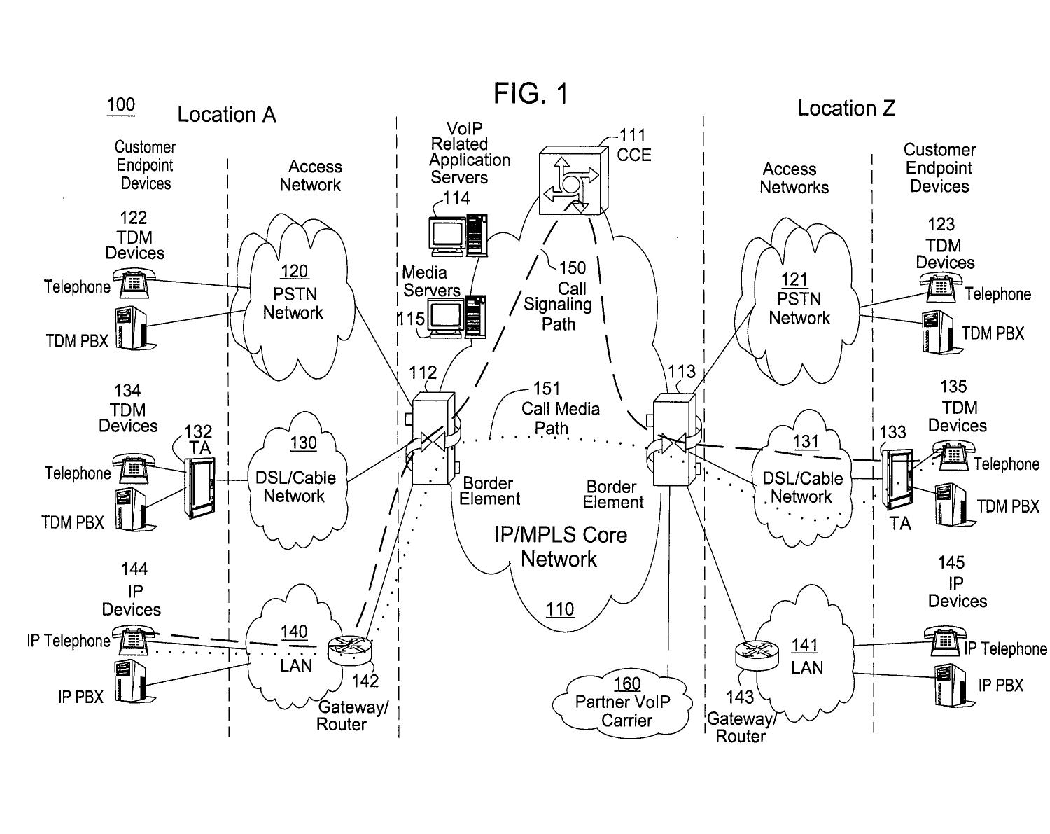

To better understand the present invention, FIG. 1 illustrates an exemplary network 100, e.g., a packet network such as a VoIP network related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a Voice over Internet Protocol (VoIP) network is considered an IP network.

In one embodiment, the VoIP network may comprise various types of customer endpoint devices connected via various types of access networks to a carrier (e.g., a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. For example, TDM based customer endpoint devices 122, 123, 134, and 135 may comprise TDM phones or Private Branch Exchanges (PBXs). IP based customer endpoint devices 144 and 145 may comprise IP phones or IP PBXs. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices may access VoIP services by using either a Public Switched Telephone Network (PSTN) 120, 121 or a broadband access network 130, 131 via a TA 132 or 133. IP based customer endpoint devices may access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and/or router 142. A packet based access network 130 or 131, such as DSL or Cable, when used together with a TA 132 or 133, is used to support TDM based customer endpoint devices.

The core VoIP infrastructure comprises of several key components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions, e.g., as shown in supporting a call media path 151. In one embodiment, the CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE, e.g., as shown in call signaling path 150. The CCE may need to interact with various VoIP related Application Servers (AS) in order to complete a call that requires certain service specific features, e.g., translation of an E.164 voice network address into an IP address and so on. For calls that originate or terminate in a different carrier, they can be handled through the PSTN 120 and 121 or the Partner IP Carrier 160 interconnections. Thus, a customer in location A using any endpoint device type with its associated access network type can communicate with another customer in location Z using any endpoint device type with its associated network type.

The above VoIP network is described to provide an illustrative environment in which data and voice packets are transmitted on communication networks. An enterprise customer may build a Virtual Private Network (VPN) to interconnect multiple sites and/or users over a network provided by a telephony service provider. The enterprise customer's devices such as Customer Edge (CE) routers at the various locations may be connected to the provider's network through Provider Edge (PE) routers. If an enterprise customer site, e.g., a VPN site, has multiple interfaces, e.g., CEs, accessing the network through the same PE router, then the multiple interfaces may share a Virtual Route Forwarding (VRF) table. For example, there may be hundreds of endpoint devices at each VPN site that are connected to the network. However, packets for the same destination prefix may have different preference for next hop. As such, if a customer needs a different forwarding table to be used for a set of interfaces/users, then the network service provider has to create a new instance of the entire VRF for this set of interfaces. That means all the routes have to be duplicated for each unique forwarding instance. Duplication of all routes for each forwarding instance is very costly. Furthermore, the approach is not easily scalable to large VPN networks serving several sites with varying needs at each site. Therefore, there is a need for a method that provides a flexible virtual forwarding table.

The present invention provides a method and apparatus for providing a flexible virtual forwarding table on packet networks. In order to clearly illustrate the teachings of the current invention, the following terminologies and networking concepts will first be described:
Virtual Private Network (VPN);
Customer Edge (CE);
Provider Edge (PE);
Border Gateway Protocol (BGP);
Label Distribution Protocol (LDP);
Forward Equivalent Class (FEC);
Label Switched Paths (LSP);
Label Edge Router (LER); and
Virtual Route Forwarding (VRF).

Virtual Private Network (VPN) is a private network that uses a public network to interconnect multiple sites and users. VPN uses virtual connections routed through the public network to connect remote sites, mobile users, corporate LANs, etc. For example, a VPN may have a LAN at a corporation's main office, remote LANs at branch offices and individual employees connecting to these LANs using endpoint devices such as PCs, laptops, mobile devices, etc. The public network may be the Internet or a network from a service provider.

Customer Edge refers to a device located at a customer location and is in communication with a provider edge device as defined below via a data link such as Ethernet, Frame Relay, etc. A customer edge device may be a router or a switch. A customer edge router is a routing peer to the provider edge device to which it is attached but not to other customer edge routers in other sites. In one embodiment, the customer edge device may provide the addresses at its site to the provider edge device using Border Gateway Protocol (BGP) as described below. The routing information about a particular VPN is present only in the PE routers attached to the VPN.

Provider Edge (PE) refers to a device, e.g., a router, administered by a network service provider and is used for communicating with customer edge devices. In one embodiment, a PE obtains routing information from the customer edge devices using Border Gateway Protocol. A PE may be used to attach labels to the customer traffic to identify the VPN associated with the packet. That is, the service provider provides VPN functionality to a set of customers using a PE device at the edge of the provider network.

Border Gateway Protocol (BGP) refers to a protocol designed to pass routing information between systems run by different administrators. BGP has methods for passing attributes of routes between a CE and a PE.

Label Distribution Protocol (LDP) is a protocol used to build label-switched router databases by exchanging label mapping information between two label switched routers.

Forward Equivalent Class (FEC) is a term that describes a set of packets that may be forwarded the same way based on characteristics or requirements. FEC may be defined based on quality of service, destination IP address, etc.

Label Switched Paths (LSPs) refer to pre-provisioned routes across an MPLS network using a signaling protocol such as Label Distribution Protocol (LDP) described above. LSPs are a sequence of labels inserted at the beginning of the packets at each device along the path from the source (or broadly a source node) to the destination (or broadly a destination node). The labels contain network protocol and information needed for forwarding packets. The LSPs are setup based on criteria in the Forward Equivalent Class (FEC) defined above.

Label Edge Router (LER) is a router located at the edge of an MPLS network that uses routing information to assign labels to data-grams and forward them into the MPLS domain. Hence, the path for a packet begins at an LER which assigns a label to it based on FEC criteria.

Virtual Route Forwarding (VRF) table refers to a routing information repository that defines the VPN membership of a customer site attached to the Provider Edge (PE) router. A VRF may contain an IP routing table, rules for determining information to be contained in the IP routing table, a forwarding table, a list of interfaces that use the forwarding table, etc. For example, when a service provider provides a VPN service to a customer, the service provider instantiates a VRF for the customer.

When packets reach a PE they are assigned the first label based on FEC and then forwarded towards their destination over one of the pre-provisioned paths (LSPs). For example, when a VPN is established for a customer, the service provider creates a Virtual Route Forwarding (VRF) instance for the VPN in the PE device. The VRF table provides the IP routing table, forwarding table, rules, etc. for the specific VPN customer. The PE device then assigns a label for the routes and distributes the routes e.g., as VPN-IPv4 addresses. The assigned label and the VPN identifier are encoded as part of network layer reach-ability information. The PE exchanges the routes with its peers using VPN and IP addressing protocols, e.g., IPv4 and VPNv4.

In one embodiment, the current invention provides one or more flexible virtual forwarding tables for customer route preference(s). The method first creates one or more virtual forwarding projection tables for route preference(s). A virtual forwarding projection table refers to a subset or a view of a VRF table containing preferred route for an interface or a set of interfaces. For example, a VRF may contain a default (summary) route learned from multiple sources, e.g., source one and source two. One interface may prefer a route with a next hop equal to source 1, while another interface prefers a route with a next hop equal to source 2.

In one embodiment, each interface may participate in one or more virtual forwarding projection tables. For example, an interface may consult a first choice virtual forwarding projection table, a second choice virtual forwarding projection table, followed by the complete VRF table. Note that routes in the VRF table are available as default. In one embodiment, the customer may designate route preference for each endpoint device, or a set of endpoint devices.

In one embodiment, virtual forwarding projection tables that an interface consults with (or participates in) may be ordered. For example, a user may designate virtual forwarding projection table 1, followed by virtual forwarding projection table 2, and so on. In one embodiment, the ordering of route preferences may be designated by a user.

In one embodiment, the customer may change route preference per session. For example, a user may provide route preferences when logging on to access a VPN service. In turn, the service provider will create a virtual forwarding projection table for the specific session based on the user specified preferences.

In one embodiment, the customer may change the ordering of route preferences per session. For example, a user may be allowed to change the ordering of route preferences when logging on to access a VPN service. Note that allowing a user to choose a specific ordering for each session from a previously established list of routes is not the same as allowing new route preferences and creating virtual forwarding projections for each session.

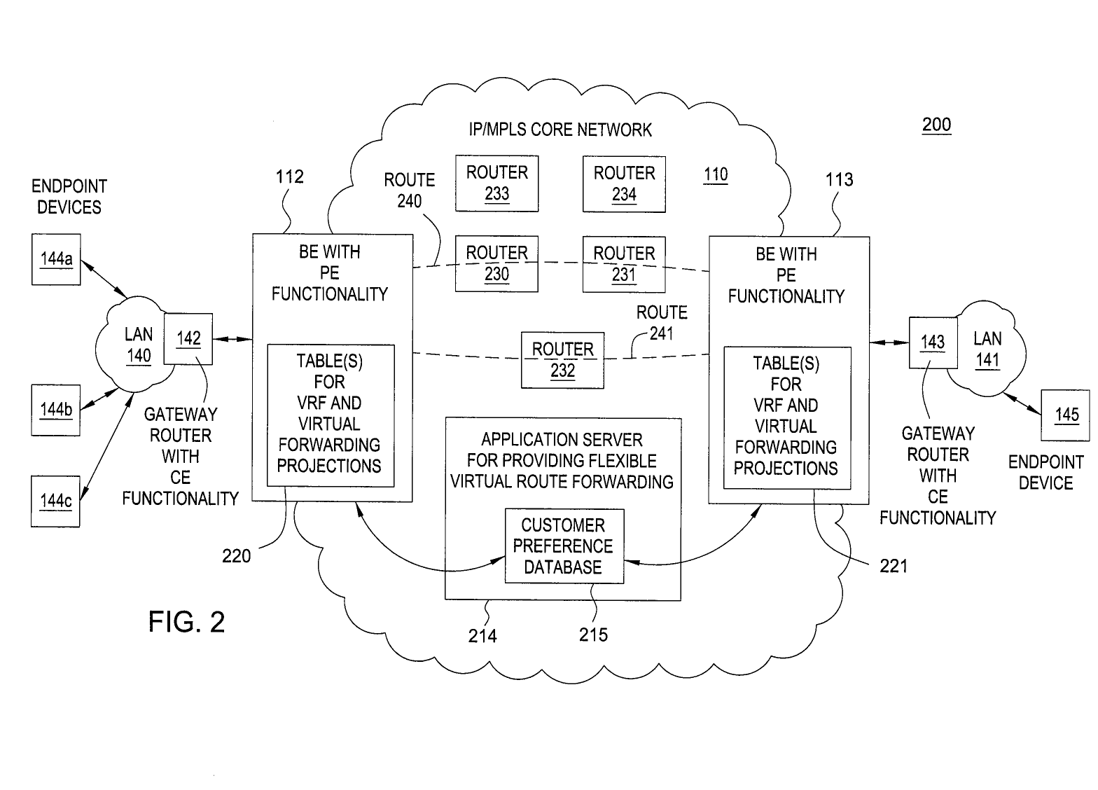

FIG. 2 illustrates an exemplary network 200 with one embodiment of the current invention for providing flexible virtual forwarding projection tables. The customers using IP endpoint devices 144a, 144b and 144c are communicating with IP device 145 over a customer LAN 140, an IP/MPLS core network 110, and a customer LAN 141. The endpoint devices 144a, 144b and 144c are connected to LAN 140 having a gateway router 142. Gateway router 142 contains CE functionality and is connected to the IP/MPLS core network 110 through the border element 112. The border element 112 contains PE functionality and also contains table(s) 220 for VRF and virtual forwarding projections.

The endpoint device 145 is connected to LAN 141 having a gateway router 143. Gateway router 143 contains CE functionality and is connected to the IP/MPLS core network 110 through the border element 113. The border element 113 contains PE functionality and also contains table(s) 221 for VRF and virtual forwarding projections. The IP/MPLS core network 110 contains routers 230-234. The IP/MPLS core network 110 also contains an application server 214 for interacting with VPN customers and providing flexible virtual route forwarding. The application server 214 contains a customer preference database 215 for implementing flexible virtual route forwarding. In one embodiment, the customer preference database is stored in a separate device, e.g., in another server, an external storage device, etc.

Packets may traverse the IP/MPLS core network from BE 112 to BE 113 using routes learned by the border elements from routers 230-234 or based on customer preference. For example, the customer may access application server 214 and requests for a VPN service with flexible virtual route forwarding. A VPN is then established through the IP network 110 to connect the LANs (access networks) 140 and 141. The customer may also provide route preferences for each user or group of users, where the application server 214 will record the customer preferences for routing in database 215. For example, endpoint devices 144a and 144b may wish to communicate with endpoint device 145 via route 240, while endpoint device 144c prefers route 241. The BEs 112 and 113 with PE functionality will build virtual forwarding projections for a user or a group of users. Subsequently, the border element 112 stores the virtual forwarding projections and the VRF to be used for forwarding packets from endpoint devices 144a, 144b and 144c as one or more tables 220. Similarly, the border element 113 will store the virtual forwarding projections and the VRF to be used for forwarding packets from the endpoint device 145 as one or more tables 221.

When a PE receives a packet, the PE will first determine whether or not there is a preferred virtual forwarding projection table that should be used for the received packet. If a preferred virtual forwarding projection table is specified for the received packet, then the PE will consult the identified virtual forwarding projection table for forwarding the received packet. More specifically, if a route for a destination prefix is successfully located in the selected virtual forwarding projection table, then the packet is forwarded using said route. However, if a route for the destination prefix does not exist in the selected virtual forwarding projection table, then the PE may select another virtual forwarding projection table, and so on, until ultimately the VRF table is selected. For example, one endpoint device may be participating in only one virtual forwarding projection table while another endpoint device may be participating in multiple virtual forwarding projection tables. It should be noted that since the VRF table contains all available routes, a route will always be found.

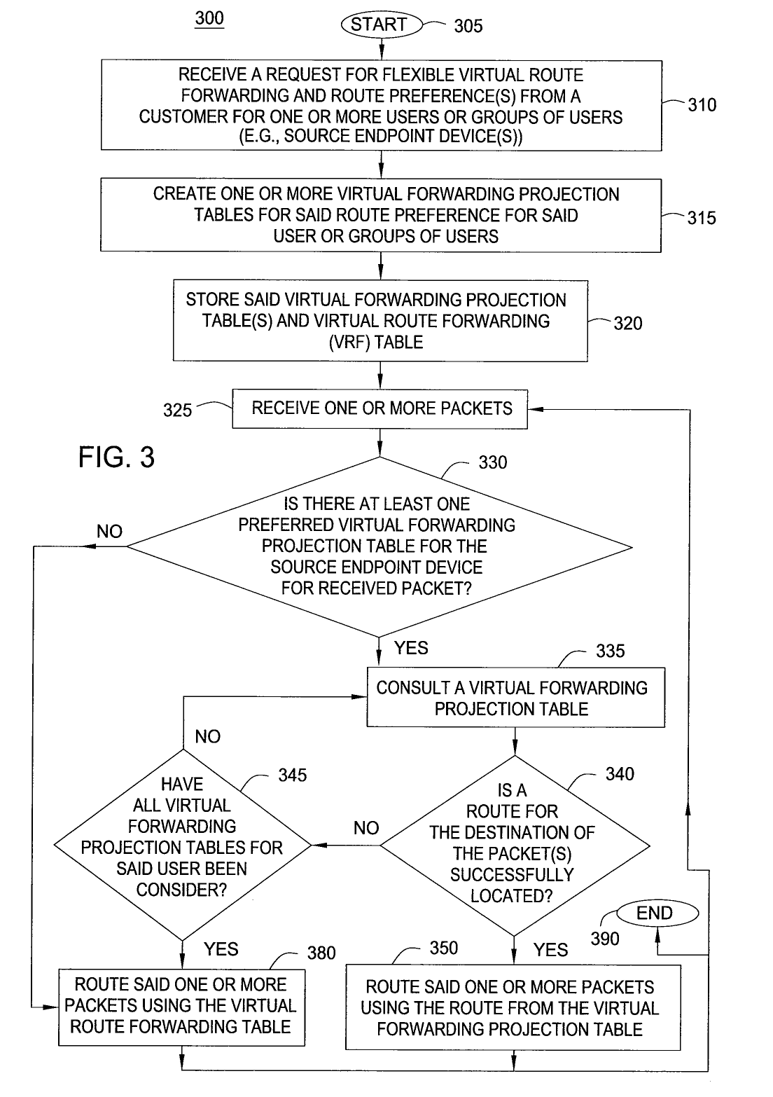

FIG. 3 illustrates a flowchart of one embodiment of the current method 300 for providing a flexible virtual route forwarding table. Method 300 starts in step 305 and proceeds to step 310.

In step 310, method 300 receives a request for flexible virtual route forwarding and route preference(s) from a customer for one or more users or groups of users. For example, a customer may access an application server and submits a request for flexible virtual route forwarding and one or more route preferences. The customer may provide route preferences for each user separately or a preference for group of users.

In step 315, method 300 creates one or more virtual forwarding projection tables for the route preferences specified for the user or group of users. For example, a provider edge router creates one or more virtual forwarding projection tables from route preferences in the database and routes learned from various peer routers. Namely, the PE has access to a VRF table containing routes to various destinations. The PE will then use the data stored on the VRF table and the preferences to create one or more virtual forwarding projection tables. Each virtual forwarding projection table contains only a subset or a partial view of the VRF table for a specific user or groups of users.

In step 320, method 300 stores the one or more virtual forwarding projection tables and VRF table. For example, since a virtual forwarding projection table may contain a list of destination prefixes and a preferred route to those prefixes, it is stored at the PE for routing packets received from a CE.

In one embodiment, an endpoint device may participate in multiple virtual forwarding projection tables. As such, the PE may need to record an order for using the multiple virtual forwarding projection tables. For example, a customer may prefer the PE to consult virtual forwarding projection table 1, followed by virtual forwarding projection table 4, followed by the VRF for an endpoint device. However, another customer may prefer consulting only one virtual forwarding projection table to be followed immediately by the VRF table, and so on. Note that if a preferred route to a destination prefix is not found in any one of the virtual forwarding projection tables, a route can still be found by using the VRF table.

In step 325, method 300 receives one or more packets, e.g., from a customer endpoint device. For example, a PE receives packet(s) from a customer of a VPN service (with flexible virtual route forwarding) for forwarding towards a user device at another location on the same VPN.

In step 330, method 300 determines whether or not there is at least one preferred virtual forwarding projection table for the source endpoint device (source endpoint device). For example, the customer may have provided route preference only for specific users and may by using VRF for other addresses. If there is at least one preferred virtual forwarding projection table for the source, then the method proceeds to step 335. Otherwise, the method proceeds to step 380, to route the packet using the VRF table.

In step 335, method 300 consults a virtual forwarding projection table. The method then proceeds to step 340.

In step 340, method 300 determines whether or not a route for the destination of the packet(s) is successfully located. If a route is located, the method proceeds to step 350. Otherwise, the method proceeds to step 345.

In step 345, method 300 determines whether or not all virtual forwarding projection tables for said user have been consulted. If all virtual forwarding projection tables have been consulted, then the method proceeds to step 380. Otherwise, the method proceeds to step 335 to consult another virtual forwarding projection table.

In step 350, method 300 routes the one or more packets using the route found in the virtual forwarding projection table. For example, the method may have located a preferred route for the packets from said user to the destination prefix. The method then proceeds to step 390 to end processing the current packet(s) or to step 325 to continue receiving packets.

In step 380, method 300 routes the one or more packets using the VRF table. For example, the method may not have found any preferred route for the destination in any of the virtual forwarding projection tables. The method then proceeds to step 390, to end processing the current packet(s) or to step 325 to continue receiving packets.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application.

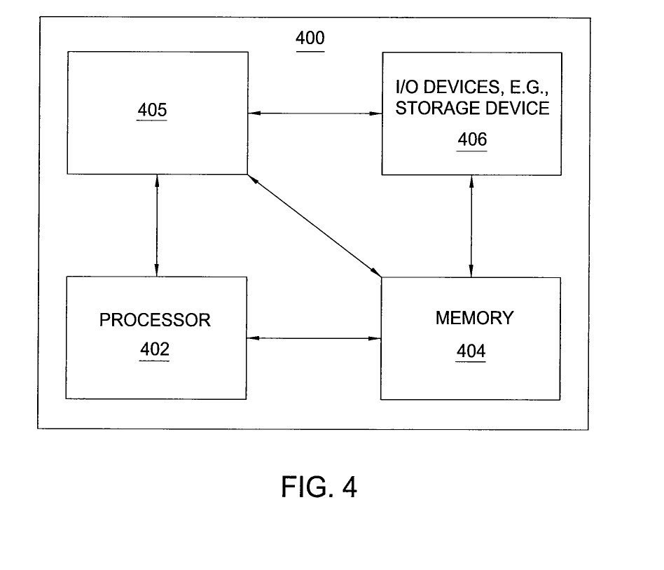

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing flexible virtual route forwarding on packet networks, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing flexible virtual route forwarding on packet networks can be loaded into memory 404 and executed by processor 402 to implement the functions as discussed above. As such, the present method 405 for providing flexible virtual route forwarding on packet networks (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for routing a packet on a packet network, comprising:
receiving one or more packets from at least one customer endpoint device, where said one or more packets are destined for a destination node;
locating a route for routing said one or more packets by consulting one or more virtual forwarding projection tables, wherein each of said one or more virtual forwarding projection tables contains a subset of the routes that are stored in a virtual route forwarding table; and
forwarding said one or more packets towards said destination node using said route.

2. The method of claim 1, wherein a route preference is associated with said at least one customer endpoint device.

3. The method of claim 1, wherein said route preference is selectively provided by a customer.

4. The method of claim 3, wherein said route preference is selectively provided by said customer on a per session basis.

5. The method of claim 1, wherein said one or more virtual forwarding projection tables are consulted in accordance with a predefined order.

6. The method of claim 5, wherein said predefined order is designated by a customer.

7. The method of claim 1, wherein said destination node is part of a virtual private network (VPN).

8. A computer-readable medium having stored thereon a plurality of instructions, the plurality of instructions including instructions which, when executed by a processor, cause the processor to perform the steps of a method for routing a packet on a packet network, comprising:
receiving one or more packets from at least one customer endpoint device, where said one or more packets are destined for a destination node;
locating a route for routing said one or more packets by consulting one or more virtual forwarding projection tables, wherein each of said one or more virtual forwarding projection tables contains a subset of the routes that are stored in a virtual route forwarding table; and
forwarding said one or more packets towards said destination node using said route.

9. The computer-readable medium of claim 8, wherein a route preference is associated with said at least one customer endpoint device.

10. The computer-readable medium of claim 8, wherein said route preference is selectively provided by a customer.

11. The computer-readable medium of claim 10, wherein said route preference is selectively provided by said customer on a per session basis.

12. The computer-readable medium of claim 8, wherein said one or more virtual forwarding projection tables are consulted in accordance with a predefined order.

13. The computer-readable medium of claim 12, wherein said predefined order is designated by a customer.

14. The computer-readable medium of claim 8, wherein said destination node is part of a virtual private network (VPN).

15. An apparatus for routing a packet on a packet network, comprising:
means for receiving one or more packets from at least one customer endpoint device, where said one or more packets are destined for a destination node;
means for locating a route for routing said one or more packets by consulting one or more virtual forwarding projection tables, wherein each of said one or more virtual forwarding projection tables contains a subset of the routes that are stored in a virtual route forwarding table; and
means for forwarding said one or more packets towards said destination node using said route.

16. The apparatus of claim 15, wherein a route preference is associated with said at least one customer endpoint device.

17. The apparatus of claim 15, wherein said route preference is selectively provided by a customer.

18. The apparatus of claim 17, wherein said route preference is selectively provided by said customer on a per session basis.

19. The apparatus of claim 15, wherein said one or more virtual forwarding projection tables are consulted in accordance with a predefined order.

20. The apparatus of claim 15, wherein said destination node is part of a virtual private network (VPN).
